(19) United States
(12) Patent Application Publication
(10) Pub. No.: US 2012/0081884 A1
(43) Pub. Date: Apr. 5, 2012

(54) ILLUMINATION SYSTEM FOR HAND WEAR

(76) Inventor: Joel GONZALEZ, Fort Lauderdale, FL (US)

(21) Appl. No.: 13/212,507

(22) Filed: Aug. 18, 2011

Related U.S. Application Data
(60) Provisional application No. 61/389,808, filed on Oct. 5, 2010.

(51) Int. Cl. F21V 21/08

(52) U.S. Cl. 362/103

(57) ABSTRACT

An illumination system is described for a hand wear item, such as for example a glove, fingerless glove, mitten, or sleeve. The hand wear item may have a palm surface and a back surface. An illumination assembly disposed on the back surface may have an electrical power source, a switch, and a plurality of lighting elements. The lighting elements may be arranged in a linear array, generating light beams in a powered state. The switch may have an off state, and one or more active states providing electrical power to a selected number of the lighting elements.

### CROSS-REFERENCE TO RELATED APPLICATION

The present application is related to and claims priority to U.S. Provisional patent application Ser. No.: 61/389,808, filed Oct. 5, 2010, entitled HANDY LIGHT—GLOVE EQUIPPED WITH 5MM LED BULBS POSITIONED OVER THE KNUCKLES TO ILLUMINATE DARK PLACES, the entirety of which is incorporated herein by reference.

### STATEMENT REGARDING FEDERALLY SPONSORED RESEARCH OR DEVELOPMENT

N/A

### FIELD OF THE INVENTION

The present invention relates to an illumination system for hand wear, such as for example gloves, fingerless gloves, mittens, or sleeves.

### BACKGROUND OF THE INVENTION

Illumination systems are available for a variety of poor lighting conditions, including for example different environments, locations and situations, as well as various professions, vocations, hobbies. Such environments may include atmospheric darkness, outdoors, indoor locations such as residential and commercial buildings, technical spaces such as for the manufacture, installation or repair of equipment, and challenging environments such as wilderness or underwater. Professions using illumination systems may include first responders such as emergency medical technicians, police and firefighters, installation and repair technicians, pilots, physicians and surgeons.

Portable lighting systems include handheld flashlights, lanterns, and penlights. Portable lights such as flashlights are generally handheld, posing challenges for any situation calling for the use of both hands. Current portable lighting systems may include lights connected to a support in a fixed or adjustable position, and may be coupled to one or more objects being viewed, a person viewing the objects, or another apparatus. They may be mounted on various types of equipment, brackets, and sporting goods such as bicycles, hats or helmets. However, many portable lighting systems are used in conditions requiring illumination for manual adjustment or operation by hand, as well as in spaces that are small or constricted, with a convoluted access path, or may even be hazardous.

It is therefore desirable to provide a personal illumination system for human hands with a combination of brightness, steady light, long life, variable illumination on demand, ease of operation, lightweight, fast operation and switching, while avoiding systems that generate too much heat, or bulky, unwieldy or uncomfortable.

It is therefore desirable to provide a personal illumination system for hand wear items, which has variable brightness or illumination pattern.

It is also desirable to provide a lighting system for hands-free use in tight or crowded environments, for complex two-handed applications or urgent situations, in a convenient form and positioning.

### SUMMARY OF THE INVENTION

The present invention advantageously provides an illumination system for a hand wear item, such as for example a glove, fingerless glove, mitten, or sleeve. In one embodiment, the illumination system may have a hand wear item sized to be disposed around portions of a human hand, and an illumination assembly disposed on the hand wear item. The hand wear item may have a palm surface and a back surface opposite the palm surface. The illumination assembly may have a flexible housing, an electrical power source, a switch, and a plurality of lighting elements. The lighting elements may be coupled to the flexible housing, electrical power source, and switch.

In another embodiment, the illumination system may have a hand wear item sized to be disposed around portions of a human hand, and an illumination assembly disposed on the hand wear item. The hand wear item may have a palm surface and a back surface opposite the palm surface. The illumination assembly may have an electrical power source, a switch, a sensor, and a plurality of lighting elements. The lighting elements may be arranged in a linear array and coupled to the electrical power source, switch, and sensor. The switch may have an off state, a first state providing electrical power to fewer than all of the lighting elements, and a second state providing electrical power to all of the lighting elements. The sensor may be operable to automatically activate the lighting elements.

In yet another embodiment, the illumination system may have a hand wear item sized to be disposed around portions of a human hand, and an illumination assembly disposed on the hand wear item. The hand wear item may have a palm surface and a back surface opposite the palm surface. The illumination assembly may have a housing, an electrical power source, a switch, and a plurality of lighting elements. The housing may have a size smaller than the back surface, a height of at most a distance between the palm surface and the back surface, and a base substantially contacting the back surface. The lighting elements may be arranged in a linear array and coupled to the housing, electrical power source, and switch. The switch may have an off state, a first state providing electrical power to fewer than all of the lighting elements, and a second state providing electrical power to all of the lighting elements.

### BRIEF DESCRIPTION OF THE DRAWINGS

A more complete understanding of the present invention, and the attendant advantages and features thereof, will be more readily understood by reference to the following detailed description when considered in conjunction with the accompanying drawings, wherein:

FIG. 1 is an illustration of an exemplary illumination system in accordance with the principles of the present invention;

FIG. 2 is another illustration of the illumination system of FIG. 1;

FIG. 3 is a perspective illustration of the illumination system of FIG. 1;

FIG. 4 is an exploded illustration of the illumination system of FIG. 1;

FIG. 5a is an electrical diagram of an exemplary illumination system in accordance with the principles of the present invention;

FIG. 5b is an electrical diagram of another exemplary illumination system in accordance with the principles of the present invention;

FIG. 6 is an illustration of another exemplary illumination system in accordance with the principles of the present invention;

FIG. 7 is an illustration of another exemplary illumination system in accordance with the principles of the present invention, showing a glove;

FIG. 8 is an illustration of another exemplary illumination system in accordance with the principles of the present invention, showing a mitten;

FIG. 9 is an illustration of another exemplary illumination system in accordance with the principles of the present invention, showing a sleeve;

FIG. 10 is a partial cross-section illustration of another exemplary illumination system in accordance with the principles of the present invention, showing a mitten;

FIG. 11 is an illustration of yet another exemplary illumination system in accordance with the principles of the present invention, showing a glove;

FIG. 12 is an illustration of the illumination system of FIG. 11;

FIG. 13 is an illustration of another exemplary illumination system in accordance with the principles of the present invention, showing a glove;

FIG. 14 is an illustration of another exemplary illumination system in accordance with the principles of the present invention, showing a fingerless glove; and

FIG. 15 is an illustration of another exemplary illumination system in accordance with the principles of the present invention, showing a fingerless glove.

### DETAILED DESCRIPTION OF THE INVENTION

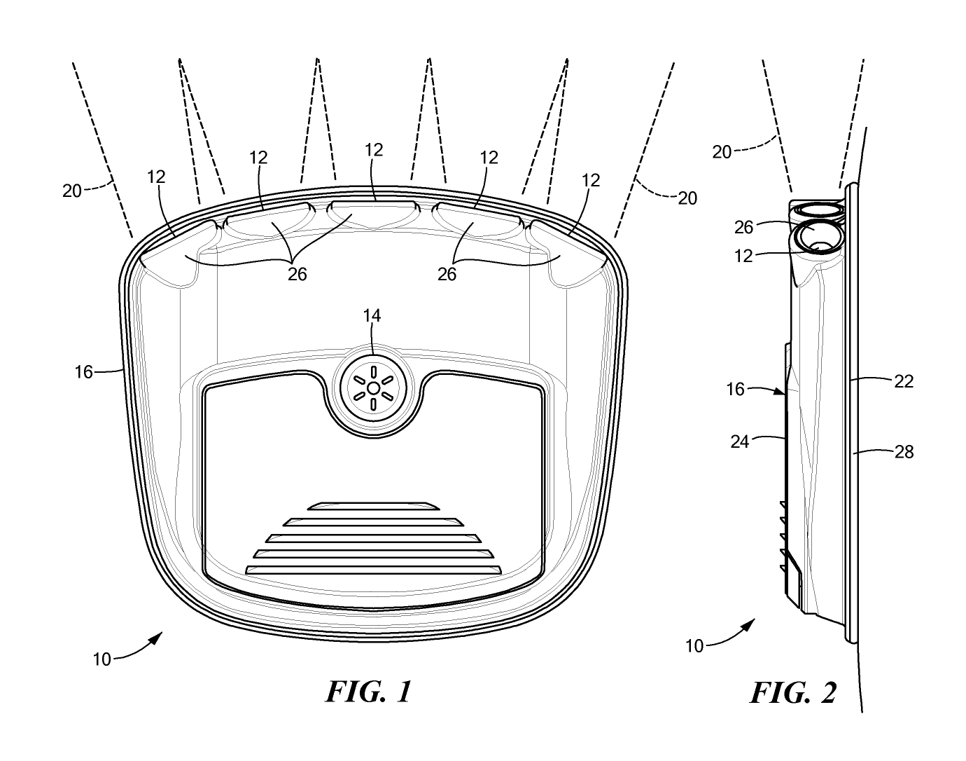

The present invention provides an illumination system for a human hand, which may include an illumination assembly disposed on a hand wear item. Referring now to the drawings in which like reference designators refer to like elements, there is shown in FIG. 1 an exemplary embodiment of an illumination system in accordance with the principles of the present invention, designated generally as 10. Of note, the components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the system and devices disclosed herein may be included in a variety of different combinations or configurations without departing from the scope and spirit of the invention.

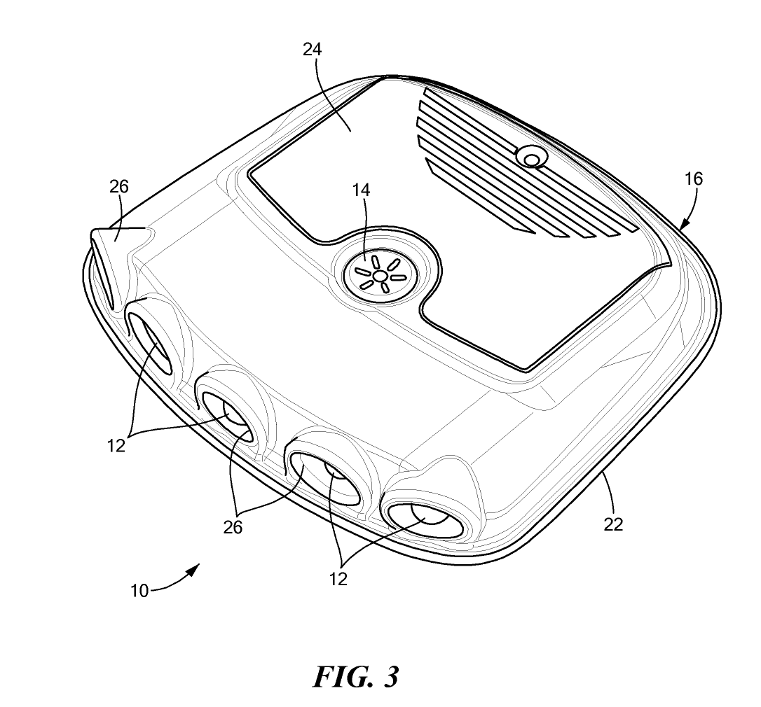

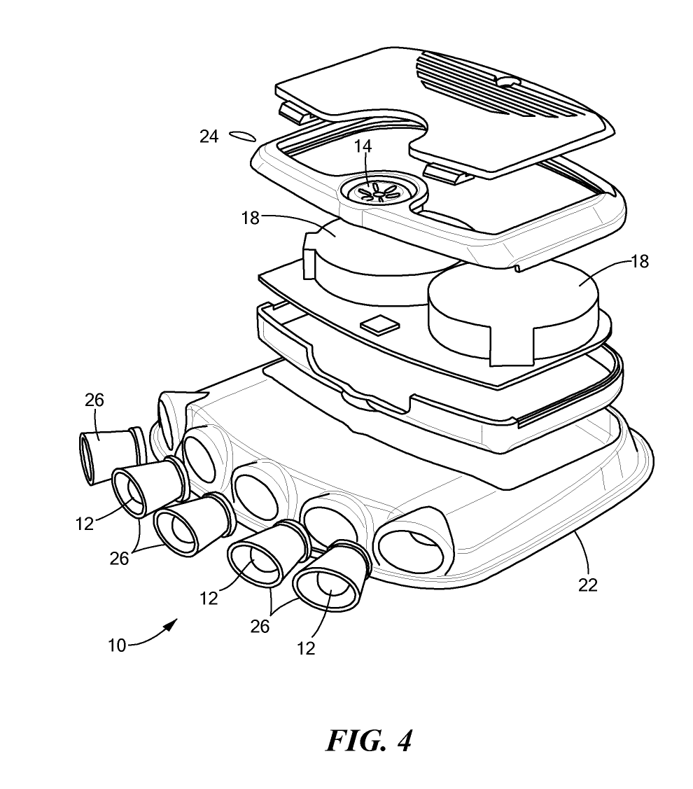

In the particular example shown in FIGS. 1-4, the illumination system 10 may generally have an illumination assembly which may include a plurality of lighting elements 12, a switch 14, a housing 16, and an electrical power source 18. A variety of different arrangements and numbers of lighting elements 12 may be selected according to characteristics such as size, brightness, lifetime of the lighting elements, color temperature, electrical power requirements, steadiness of illumination, variable operation and illumination, speed of transition to on and off states, and heat generated during operation.

Any suitable number of lighting elements 12 may be selected, ranging from one to many. For example, a single lighting element 12 may be provided, or a small group of two to five lighting elements 12, ranging up to an array of many lighting elements which may number one hundred or more in a pixelized lighting assembly. In the particular example shown in FIGS. 1-4, an array of five lighting elements 12 is provided.

During operation in a powered state, the lighting elements 12 may generate light beams 20, which may be directed in an expansive pattern as shown in FIG. 1, or may be parallel or in a compressing focused pattern. Accordingly, the lighting elements 12 may be all aligned in a diverging array, substantially parallel to each other, or a converging array, or some other arrangement. The lighting elements 12 and may have a brightness ranging from approximately ten lumens to hundreds of lumens per lighting element. The lighting elements 12 may be selected to all produce uniform or similar level of brightness, or one or more lighting elements 12 may have different brightness values. The lighting elements 12 may also have variable or selectable brightness, which may include one or more lower and higher brightness operational settings. The lighting elements 12 may be of various types, including incandescent, fluorescent, chemical, halogen, and light-emitting diodes (LED).

The lighting elements 12 may be selected among various sizes, including those as small as a millimeter in width, intermediate sizes such as 5-10 millimeters, to larger sizes of several centimeters. The lighting elements 12 may be selected among various shapes, including rounded, circular, partially spherical, rectangular, square, polygonal, linear, or curved. Some lighting elements such as for example incandescent bulbs project light in all available directions, while for example LEDs may have limited visual angles.

The light beams 20 may have various colors individually or collectively, such as for example white, red, pink, yellow, green, blue, and violet. Such colors may be realized by for example colored bulbs or LEDs, or a colored filter or lens. The light beams 20 may also be selected at different portions of the spectrum, such as for example infrared, ultraviolet, monochromatic, multichromatic, and laser. In a particular example, a series of five lighting elements 12 may be provided, each of which may be an LED of 5 mm diameter producing light characterized as white in color.

The switch 14 may have various selectable states, including an off state and other states providing electrical power from the power source 18 to a selected number of the lighting elements 12. In an example illumination assembly having at least two illumination elements 12, the switch 14 may have a first state conducting electrical power to fewer than all of the lighting elements 12, and a second state conducting electrical power to all of the lighting elements 12. The switch 14 may alternately have a state providing electrical power to only one of the lighting elements 12. In illumination assemblies having more than two illumination elements 12, the switch 14 may also have additional intermediate states to light up or provide power to intermediate numbers of illumination elements 12. The switch 14 may have alternate states, for example providing electrical power to all of the lighting elements 12 in an activation pattern such as flashing, strobing, or lighting in a selected sequence.

The housing 16 generally provides a structural framework, as well as a protective enclosure, for the other components of the illumination assembly. The housing 16 may be sized for use on a human hand, and may have a size, shape and configuration that is relatively light, maneuverable and compact, unobtrusive, and not bulky or unwieldy. Accordingly, the illumination assembly may have a shape, size, and weight allowing for ease of use, dexterity in hand motions without fatigue, and access to narrow passages or access pathways, without being bulky or unwieldy.

For example, the housing 16 may be the same size or smaller than the back of a representative hand, and have a height of at most a distance between the palm surface and the back surface. The housing 16 may be made of various materials having desired characteristics, which may include, strength, resilience, flexibility, and light weight. Some possible materials for the housing 16 include polymers such as polycarbonate and rubber, and metals such as steel or aluminum. The housing 16 may be flexible to fit a larger range of hand sizes and shapes, and provide for greater comfort during use.

A specific embodiment may for example have dimensions on the order of a length and width ranging from 0.25 to 5 inches with a representative value of approximately 3 inches, and a height ranging from 0.1 to 2 inches with a representative value of approximately 0.5 inches. The example illumination system of FIG. 1 shows a housing 16 which may include a base 22 and a top element 24. In the case of a power source 18 that is sealed inside the housing 16, or is otherwise not replaceable, the housing 16 may be imperforate and have no openings. Alternately, various openings may be provided to enable access to the illumination assembly for repairs, maintenance, or for replacement of the power source. Such openings may for example be one or more vents, doors, flaps or access panels to provide access to an interior of the housing, which may in turn have a suitable releasable closure device such as for example a latch, lock, lever, fastener, screw, snap, and the like.

The housing 16 may include features shaped to at least partially protect each of the lighting elements 12, such as for example surrounds 26. The surrounds 26 may also include one or more optical elements which may be in the form of one or more reflectors, refractors, or lenses. For example, reflectors may have various shapes including partially spherical, parabolic, conical, or faceted; and may be made of any suitable material having an optically reflecting characteristic including metals, chrome, mirrors, reflective polymers and coatings. Refractors and lenses may have various shapes including planar, angled, or curved, convex or concave, to produce the desired lighting. One or more components of the illumination assembly may be adjustable to provide selectable or variable brightness or to adjust a width or shape of the light beams.

The electrical power source 18 may be selected for desired characteristics, including voltage, current, performance, stable power, expected lifetime, and whether it is rechargeable. Examples may include one or more batteries stored in the housing, or a conduit or other connection to an external power source, or the illumination assembly may have one or more alternate power sources such as a solar panel for recharging the batteries. If the housing 16 is imperforate, it may also have terminals for contacting an external recharger or other power supply for the purpose of recharging a power source such as a battery inside the housing. Moreover, the housing 16 may also be substantially water resistant, or resistant to other adverse environments.

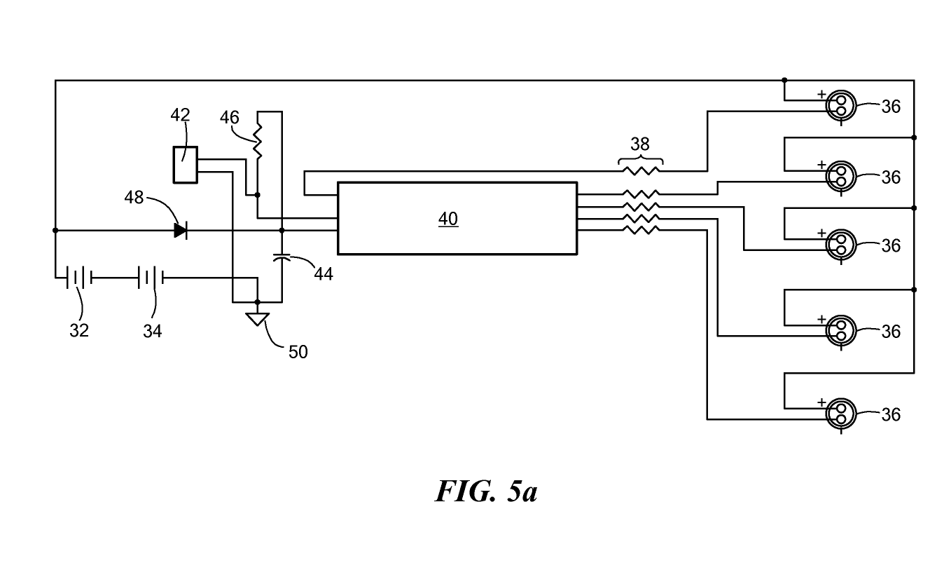

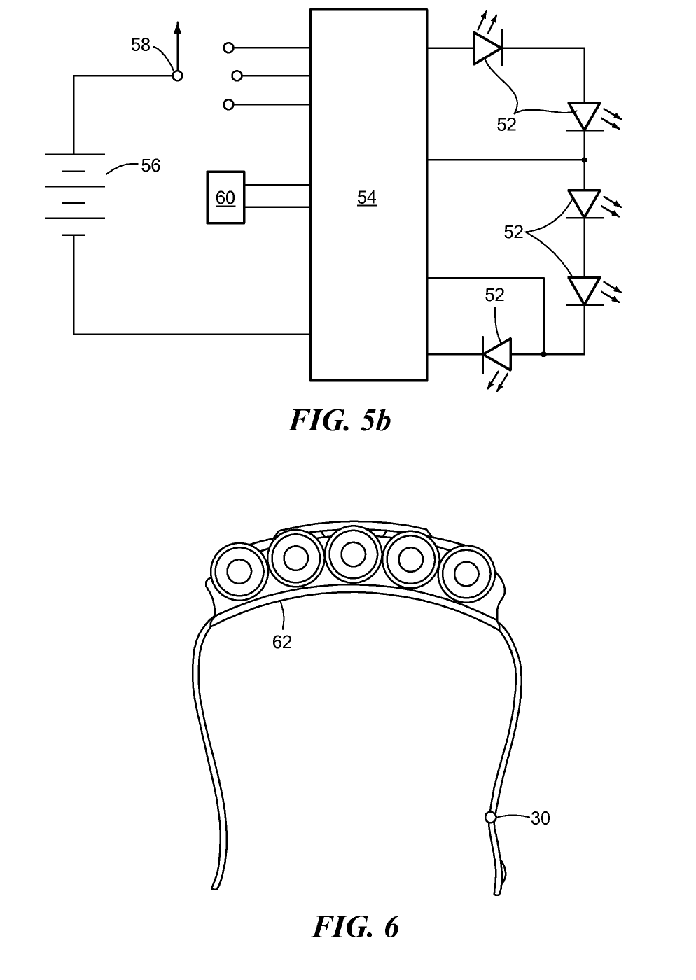

FIGS. 5a and 5b illustrate examples of electric wiring diagrams. The illumination system 10 may be electronically assembled using various components, including for example one or more power sources such as batteries, as well as resistors, capacitors, switches, diodes, electronic processors or circuit boards, and illumination elements such as bulbs or LEDs. The electric circuit may be made in various arrangements including series or parallel connections, and the lighting elements in particular may be connected in series or parallel. Specifically, FIG. 5a shows a first battery 32 and a second battery 34, a group of five LEDs 36 and five associated resistors 38, an electronic processor 40, a switch 42, capacitor 44, resistor 46, diode 48, and ground 50. In a specific example, the batteries 32 and 34 may be selected from among those commercially available, for example batteries having cylindrical, rectangular, or button/coin shapes. Possible battery chemistry includes for example alkaline, nickel cadmium, nickel metal hydride, carbon-zinc, lithium, lithium polymer rechargeable, lithium-ion, lithium manganese dioxide, and silver-oxide. The five LEDs 36 may be selected from 2 mm to 10 mm in diameter or greater, and in any color, such as for example 5 mm diameter white LEDs.

In the example shown in FIG. 5a, the positive terminals of the LEDs 36 are connected to the batteries 32 and 34 in parallel, and the other terminals of the LEDs 36 are individually connected through resistors 38 to the electronic processor 40. The electronic processor 40 may be selected from among those commercially available and suitable, for example a programmable chip such as an EPROM. The switch 42 may be of various types, including a two-way on/off switch or multi-way switches. In a specific example, the switch 42 may be a four-way switch providing the following operational selections: off, one light on, three lights on, and all five lights on. In another specific example, the switch may be a five-way switch providing operational selections of off, one light on, three lights on, all five lights on, and all five lights flashing.

In the example shown in FIG. 5b, five LEDs 52 are provided and wired in series with each other and coupled to an electronic processor 54, with alternate connections between the LEDs 52 for selective operation. A power source 56 is provided, as is a four-way switch 58. In addition, a sensor 60 may be provided for automatically actuating the lighting system 10 upon sensing one or more selected conditions. The sensor 60 may operable to automatically actuate the LEDs 52 upon sensing a condition such as for example ambient light intensity, water, non-aqueous liquids, gas, and motion. In specific examples, the sensor 60 may turn the LEDs 52 on when sensing ambient darkness, or upon contacting water in a nautical situation, or after sensing various liquids or gases that may represent a hazardous situation, or when sensing motion, or even after detecting a lack of motion for a selected period of time which may indicate unconsciousness to facilitate rescue.

The illumination assembly may also have a releasable fastener, removably fastening the illumination assembly to the hand wear item. Any suitable type of fastener may be used, such as for example a hook and loop fastener 28 as shown in FIG. 1 or a releasable strap and buckle 30 as shown in FIG. 6.

Alternately, the illumination assembly may have various shapes, and in particular may have a non-planar shape. In the example of FIG. 6, the illumination assembly has a base 62 which is curved around a longitudinal axis. The base may have any other suitable shape, including for example faceted, concave, convex, or non-symmetrical.

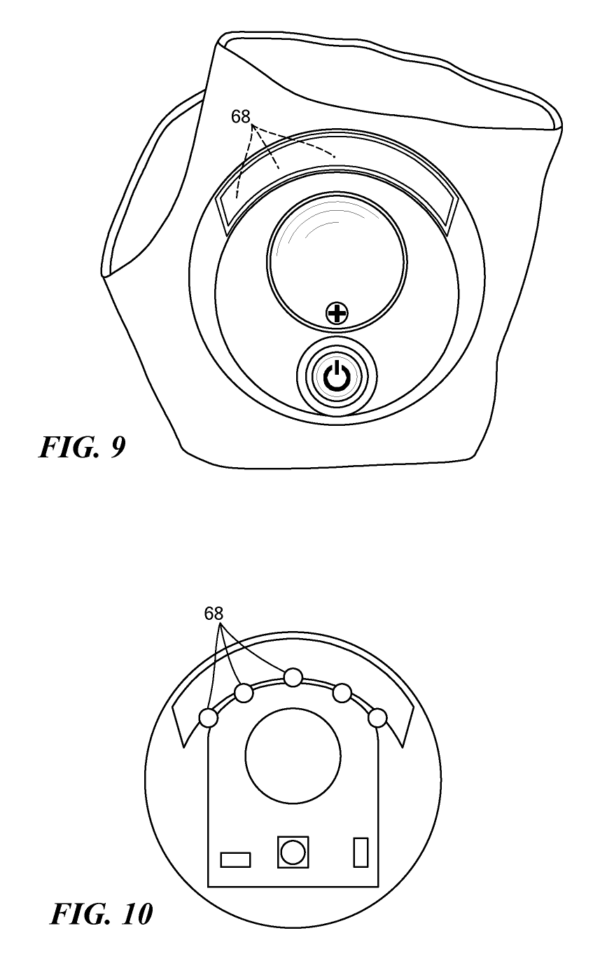

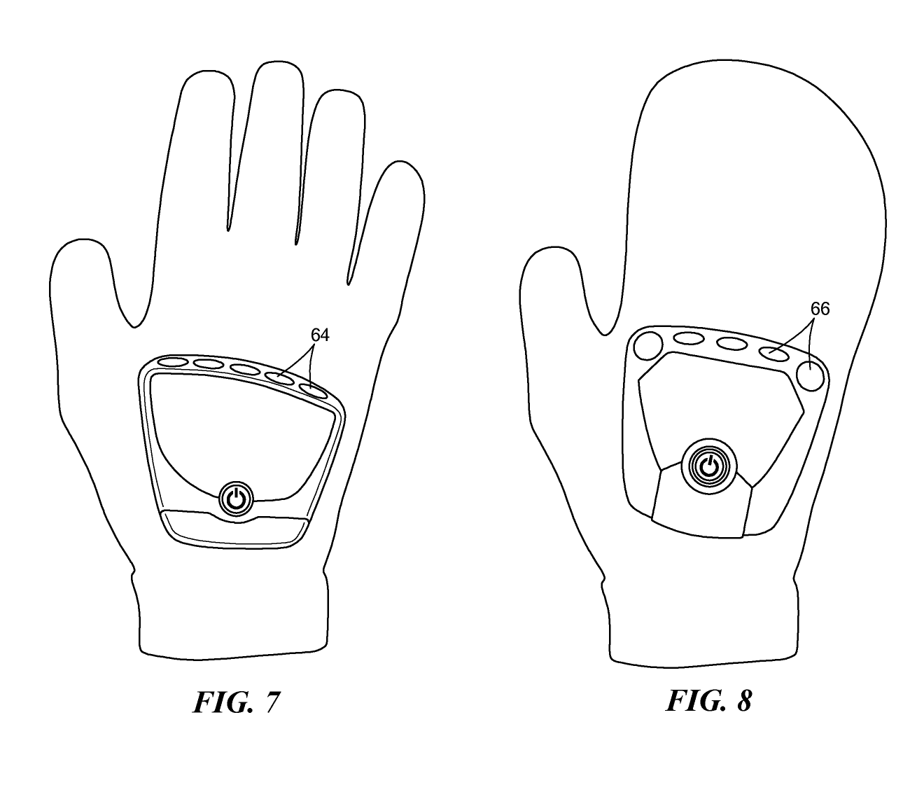

As illustrated in FIGS. 1, 7 and 8, the lighting elements may have a variety of arrangements and positions. For example, the lighting elements may be substantially coplanar with a back surface of the hand, and may be arranged in a substantially linear array. The lighting elements may be positioned along a line at an acute angle with respect to the wrist opening. The lighting elements may be positioned along a curved or segmented line. In the example of FIG. 7, the illumination assembly has an array of lighting elements 64 arranged at an acute angle with respect to a wrist opening of the hand wear item. The array of lighting elements 64 may alternatively be described as being at an obtuse angle with respect to a longitudinal axis.

In the example of FIG. 8, the illumination assembly has an array of lighting elements 66 having different sizes, with an outer pair of lighting elements being larger than a remainder of the lighting elements. In the example of FIGS. 9 and 10, the illumination assembly has a circular shape with an interior array of lighting elements 68 arranged in an arcuate pattern.

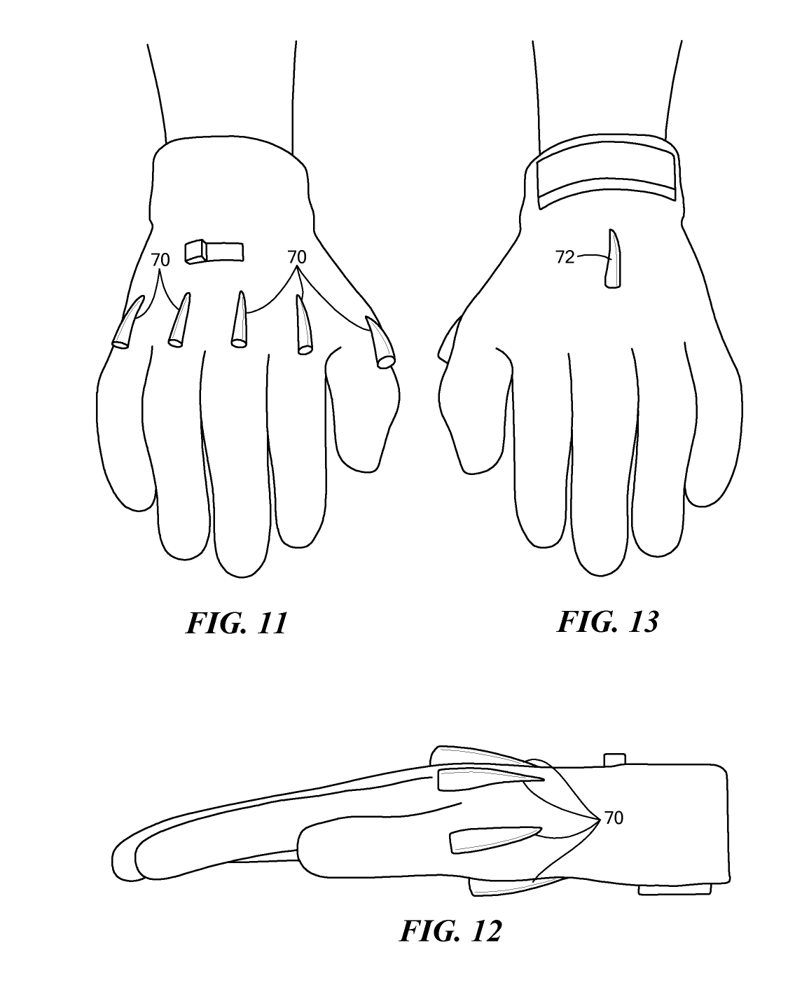

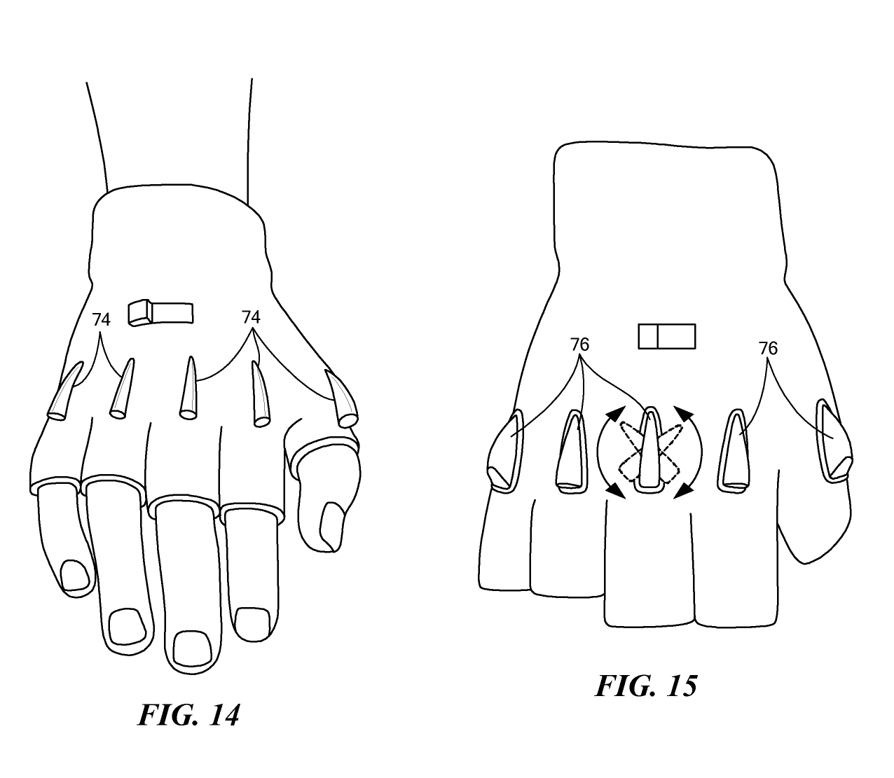

In the example of FIGS. 11 and 12, the illumination assembly has an array of lighting elements 70, each individually disposed on a hand wear item. In the example of FIG. 13, the illumination assembly has a single lighting element 72 disposed on a hand wear item. In the example of FIG. 14, the illumination assembly has an array of individual lighting elements 74 disposed on a hand wear item. In the example of FIG. 15, the illumination assembly has an array of individual lighting elements 76 disposed on a hand wear item, in which at least one lighting element is movable to point in a range of directions.

The hand wear item may be of various types, such as for example a glove, fingerless glove, mitten, and sleeve. FIGS. 7 and 11-13 show gloves, FIG. 8 shows a mitten, FIG. 9 shows a sleeve, and FIGS. 14-15 show fingerless gloves.

Material selection for the hand wear item and all the components of the illumination assembly may be made with a view to desirable properties, including strength, weight, shape, finish, a solid feel, color, pattern and quality. Among many possible materials for the hand wear item, various fabrics may be used such as natural materials including wool, cotton, felt, and leather, or other materials including woven nylon, polyester, and neoprene.

Alternately, additional components may be added to the illumination system and coupled either to a hand wear item or an illumination assembly, such as for example a laser-projecting level, providing a visual indication of horizontal and/or vertical for hanging decorative items on walls or for construction. Further example features may include a laser range finder, which may be used to measure a variety of distances, or a laser designator such as for example for use with night vision equipment. As another example, a bracket or magnet may be included to hold items or tools, small metal components or wires or fasteners such as screws. An additional feature may be visual enhancements, including for example magnifiers or display screens. Yet another example feature may include an electronic scanner such as for example an optical reader that can scan barcodes, quick response (QR) codes, and the like, which may be coupled with either a hand wear item or an illumination assembly.

It will be appreciated by persons skilled in the art that the present invention is not limited to what has been particularly shown and described herein above. In addition, unless mention was made above to the contrary, it should be noted that all of the accompanying drawings are not to scale. A variety of modifications and variations are possible in light of the above teachings without departing from the scope and spirit of the invention, which is limited only by the following claims.

What is claimed is:

1. An illumination system, comprising:
a hand wear item sized to be disposed around portions of a human hand, and having a palm surface and a back surface opposite the palm surface; and
an illumination assembly disposed on the back surface and having a flexible housing, an electrical power source, a switch, and a plurality of lighting elements; the lighting elements being coupled to the flexible housing, electrical power source, and switch.

2. The illumination system of claim 1, wherein the lighting elements are arranged substantially coplanar with the back surface.

3. The illumination system of claim 1, wherein the lighting elements are all aligned substantially parallel to each other.

4. The illumination system of claim 1, wherein the lighting elements are positioned along a line at an acute angle with respect to the wrist opening.

5. The illumination system of claim 1, wherein the lighting elements are positioned along a curved line.

6. The illumination system of claim 1, wherein at least one lighting element is movable with respect to the hand wear item.

7. The illumination system of claim 1, the switch further comprising a third state providing electrical power to all of the lighting elements in a flashing pattern.

8. The illumination system of claim 1, having at least three lighting elements; wherein the first state provides electrical power to more than one of the lighting elements; the switch further comprising a third state providing electrical power to only one of the lighting elements.

9. The illumination system of claim 1, wherein the lighting elements are of a type selected from the group consisting of incandescent, fluorescent, chemical, halogen, light-emitting diode, laser, infra-red, and ultraviolet.

10. The illumination system of claim 1, the beams having a color selected from the group consisting of white, red, pink, yellow, green, blue, violet, infrared, monochromatic, and multichromatic.

11. The illumination system of claim 1, wherein the light beams have a brightness of approximately 10-90 lumens.

12. The illumination system of claim 1, the flexible housing having a base substantially contacting the back surface which is curved around a longitudinal axis.

13. The illumination system of claim 12, the flexible housing having a length and width of at most 4 inches, and a height of at most 0.5 inches.

14. The illumination system of claim 1, the flexible housing being substantially water resistant.

15. The illumination system of claim 1, further comprising a sensor coupled to the switch and operable to automatically actuate the lighting elements.

16. The illumination system of claim 15, wherein the sensor actuates the lighting elements upon sensing a condition selected from the group consisting of ambient light intensity, water, non-aqueous liquids, gas, and motion.

17. The illumination system of claim 1, further comprising a releasable fastener removably fastening the illumination assembly to the hand wear item.

18. The illumination system of claim 1, wherein the hand wear item is of a type selected from the group consisting of glove, fingerless glove, mitten, and sleeve.

19. An illumination system, comprising:
a hand wear item sized to be disposed around portions of a human hand, and having a palm surface, a back surface opposite the palm surface, and a wrist opening; and
an illumination assembly disposed on the hand wear item and having an electrical power source, a switch, a sensor, and a plurality of lighting elements;
the lighting elements being arranged in a linear array and coupled to the electrical power source, switch, and sensor;
the switch having an off state, a first state providing electrical power to fewer than all of the lighting elements, and a second state providing electrical power to all of the lighting elements;
the sensor being operable to automatically actuate the switch.

20. An illumination system, comprising:
a hand wear item sized to be disposed around portions of a human hand, and having a palm surface and a back surface opposite the palm surface; and
an illumination assembly disposed on the hand wear item and having a housing, an electrical power source, a switch, and a plurality of lighting elements;
the housing having a size smaller than the back surface, a height of at most a distance between the palm surface and the back surface, and a base substantially contacting the back surface;
the lighting elements being arranged in a linear array and coupled to the housing, electrical power source, and switch;
the switch having an off state, a first state providing electrical power to fewer than all of the lighting elements, and a second state providing electrical power to all of the lighting elements.
